(19) United States
(12) Patent Application Publication
(10) Pub. No.: US 2003/0080470 A1
(43) Pub. Date: May 1, 2003

(54) Plunger-type injection molding unit with improved flushing feature, and method for operating the plunger-type injection molding unit

(75) Inventor: Michael Zellerohr, Kleve (DE)

Correspondence Address: Henry M. Feiereisen, Suite 3220, 350 Fifth Avenue, New York, NY, 10118, US

(73) Assignee: KRAUSS-MAFFEI KUNSTSTOFFTECHNIK GMBH, Munchen (DE)

(21) Appl. No.: 10/266,100

(22) Filed: Oct. 7, 2002

(30) Foreign Application Priority Data
Oct. 6, 2001 (DE) 101 49 429.7

(51) Int. Cl. B29C 45/02; B29C 45/53

(52) U.S. Cl. 264/328.19; 425/549; 425/557

(57) ABSTRACT

A plunger-type injection molding unit includes a cylinder in which a plunger is accommodated for axial displacement. The plunger has an end face to define with the cylinder an antechamber which receives melt through an inlet port. The cylinder has an injection port in substantial confronting relationship to the end face of the plunger, whereby a flow of melt through the injection port is regulated by a closing mechanism. The plunger is provided with a flow channel for conducting melt from the antechamber, whereby the flow of melt through the flow channel is regulated by a closing device.

### CROSS-REFERENCES TO RELATED APPLICATIONS

This application claims the priority of German Patent Application, Serial No. 101 49 429.7, filed Oct. 6, 2001, pursuant to 35 U.S.C. 119(a)-(d), the disclosure of which is incorporated herein by reference.

### BACKGROUND OF THE INVENTION

The present invention relates, in general, to a plunger-type pre-plasticizing injection molding unit

Plunger-type injection molding units, which do not operate according to the “first-in-first-out” principle, i.e. in a way in which the melt injected first is not ejected again first, oftentimes display shortcomings as far as a self-cleaning feature is concerned. Plastic deposits are experienced in particular directly upon the end face of the plunger and are not expelled during each injection operation but remain in the plunger space, oftentimes for a very long time. Thus, when paint or material is changed, extended shutdown periods are experienced for purging the injection molding unit with melt so as to remove and flush out remaining melt residues in the antechamber. This is not only very time-consuming but also cost-intensive in view of the many waste parts being generated.

Pre-plasticizing injection molding units are known in which the supply of melt into the antechamber ahead of the plunger as well as the plunger itself are so configured that the injection of melt ensures a sufficient purging with swirling of remaining melt residues. Examples of such injection molding units are described in German Pat. No. DE 43 95 826 C2, U.S. Pat. No. 3,298,061, European Pat. No. 1,120,222 A2 as well as Japanese Pat. No. 101 38 301 A.

International patent publication WO 00/78523 A1 to Husky describes a plunger-type injection molding unit in which the plunger is arrested in a forward disposition and the remaining space is purged as the melt inlet is designed to promote flushing. The melt outlet is hereby the injection opening. Another approach in this prior art proposed a movement of the plunger into a purge position, which corresponds to a greater deflection than during normal injection operations. As a consequence, a leakage outlet is cleared at the piston edge for flushing purposes as the plunger is arrested in this position. The leakage outlet has a ring-shaped channel in the inner cylinder wall so that the cylinder head is evenly swept during the purging process.

Common to all conventional injection molding units is their inability to expel aged deposits upon the plunger end face with minimal flushing material.

It would therefore be desirable and advantageous to provide an improved injection molding unit to obviate prior art shortcomings and to enable a removal of deposits from the plunger end face with a minimum of flushing material.

### SUMMARY OF THE INVENTION

According to one aspect of the present invention, an injection molding unit includes a cylinder; a plunger received in the cylinder for axial displacement and having an end face defining with the cylinder ahead of the plunger an antechamber which receives melt through an inlet port, wherein the cylinder has an injection port in substantial confronting relationship to the end face of the plunger, with the plunger having a flow channel to form a flushing opening for conducting melt from the antechamber; a closing mechanism for regulating a flow of melt through the injection port; and a closing device for regulating a flow of melt through the flow channel.

The present invention resolves prior art problems by providing a flow channel in the plunger to form the flushing opening. In this way, melt used for purging is not discharged through the injection port but via an outlet port which is integrated in the plunger. This results in better flushing quality. The plunger may hereby be designed as stepped plunger with an outer cross section which is smaller that a maximum size at the plunger end face to minimize friction between the plunger and the cylinder.

According to another feature of the present invention, there may be provided a discharge device for removing melt migrated to an area between cylinder and plunger.

According to another feature of the present invention, heating elements, e.g., heating cartridges, may be provided in the plunger substantially along the length of the flow channel for maintaining the melt in liquid state as it flows during purging operation via the flow channel, and for ensuring a reliable operation.

According to another feature of the present invention, the plunger end face may have a shape enhancing flow dynamics to realize an effective flushing action.

According to another feature of the present invention, the flow channel may be provided in the form of an axial inner bore at least in an area of the end face of the plunger. For example, the plunger end face may be configured to taper in a funnel-shaped manner toward the inner bore. In this way, melt deposits on a cylinder-adjacent peripheral area of the plunger end face can easily be detached and removed by the flow profile.

Suitably, the closing device may be realized as a valve, which is attached to the plunger and is easy to control. The closing mechanism may be implemented as a shut-off nozzle or a control valve disposed in the melt inlet port so as to allow ejection of melt from the antechamber of the plunger in a first end position and filling of the antechamber with melt in a second end position.

According to another aspect of the present invention, a method of operating a plunger-type injection molding unit, includes the steps of closing an injection port provided for introduction of melt into an antechamber of a plunger of an injection molding unit; filling melt into the antechamber to thereby move the plunger backwards; opening a closing device disposed within a flow channel of the plunger; and moving the plunger forwards in axial direction to allow melt to flow to the outside through the flow channel.

In such a method, the plunger is moved to an initial position, which corresponds to the position at the beginning filling operation, when melt is injected into the antechamber. Then the injection port is closed and the antechamber is filled with melt. This filling process is accompanied by a retraction of the plunger in axial direction. As soon as the plunger reaches the end position, the closing device opens and the plunger is moved in opposite direction, i.e. forwards in axial direction. As a result, melt is displaced from the antechamber through the flow channel to thereby flush out melt residues deposited along the inner wall of the cylinder and on the end face of the plunger. Subsequently, the closing device closes the flow channel. The flushing operation may be repeated until outgoing melt is clean enough or a new injection process is intended. As the plunger end face has a shape to enhance flow dynamics, the overall efficiency is increased because the flow of melt around the plunger surface is improved and deposits can be removed more rapidly.

As an alternative, it is also possible to operate an injection molding unit of a type involved here in such a manner that the plunger can be held in place in any desired position. After closing the injection port, the closing device disposed within a flow channel of the plunger is closed and melt is injected into the antechamber through the inlet port. Melt can hereby flow to the outside through the flow channel to flush out contaminants. A better flushing result may be realized by repeating the flushing process, whereby the position of the plunger may be varied over the entire plunger stroke.

By immobilizing the plunger during flushing, melt used for the flushing process can easily be disposed of.

While the melt outlet has to be connected flexibly with a waste container in the event the injection molding unit has a movable plunger, the use of a stationary plunger according to the alternative method eliminates the need for such a flexible connection. The latter case requires only the provision of a collecting basin in the area of the outlet.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a sectional view of a first embodiment of a plunger-type injection molding unit according to the present invention;

FIG. 2 is a sectional view of a second embodiment of a plunger-type injection molding unit according to the present invention;

FIG. 3 is a sectional view of a third embodiment of a plunger-type injection molding unit according to the present invention; and

FIG. 4 is a sectional view of a fourth embodiment of a plunger-type injection molding unit according to the present invention

### DETAILED DESCRIPTION OF PREFERRED EMBODIMENTS

Throughout all the Figures, same or corresponding elements are generally indicated by same reference numerals.

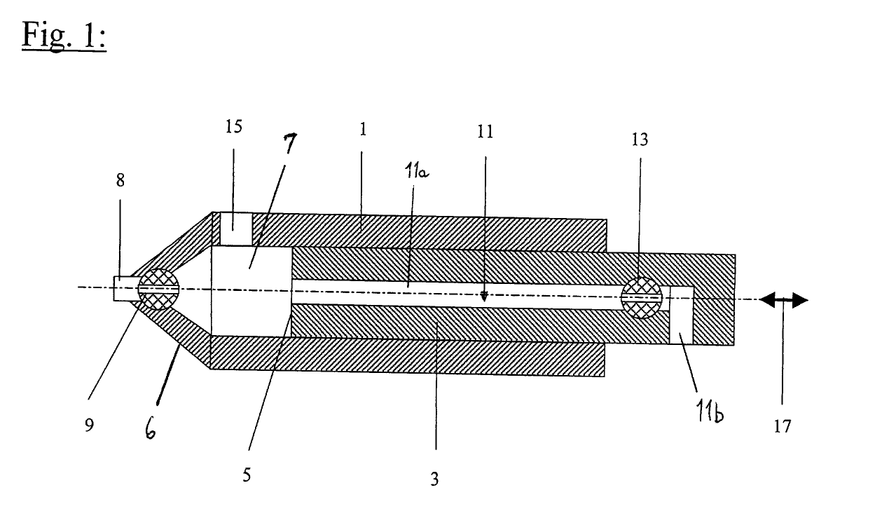

Turning now to the drawing, and in particular to FIG. 1, there is shown a sectional view of a first embodiment of a plunger-type injection molding unit according to the present invention, including a cylinder 1 and a plunger 3 supported in the cylinder 1 for movement in an axial direction, as indicated by double arrow 17. The plunger 3 has a plunger end face 5 which defines in conjunction with the cylinder 1 an antechamber 7 ahead of the plunger 3. At is forward end, the cylinder 1 has a tapered tip portion 6 which includes a central injection port 8 for ejection of melt into an injection mold (not shown). A flow of melt through the injection port 8 is regulated by a closing mechanism 9 in the form of a turning valve or shutoff nozzle. In proximity to the tip portion 6, the cylinder 1 is formed with a material inlet port 15 through which melt is fed into the antechamber 7 of the plunger 3 from a plasticizing unit (not shown). The plunger 3 includes a flow channel 11 which is formed by two blind end bores 11a, 11b. Disposed in a rear portion of the flow channel 11 is a closing device 13, e.g. a control valve, to regulate a flow of melt, used for implementing a flushing process, through the flow channel 11.

As shown in FIG. 1, the flow channel 11 is configured in the plunger 3 as an axial inner bore extending inwardly from the plunger end face 5. The outlet side of the flow channel 11 at the end distal to the plunger end face 5 may be suited to the constructional situations at hand.

The injection molding unit for carrying out a flushing process operates as follows: The plunger 3 is moved to a forward (left) end position to allow injection of melt to fill the antechamber 7 during normal injection operation. The injection port 8 is hereby closed by the closing mechanism 9. Melt can thus be introduced through the inlet port 15 to commence with a filling of the antechamber 7. As the antechamber 7 is filled with melt, the plunger 3 moves backwards, i.e. to the right in FIG. 1. The displacement of the plunger 3 may be effected freely or controlled by a suitable mechanism. Once the antechamber 7 is filled with a desired amount of melt and the plunger 3 has reached the rear end position, the filling operation is stopped and the closing device 13 opens to allow passage of melt. The plunger 3 is now moved forward (to the left in FIG. 1) so that melt from the antechamber 7 is pushed through the flow channel 11 to the outside. Hereby, residual melt deposits on the inside wall of the cylinder 1 and the plunger end face 5 are flushed out. The removed melt is then collected in a waste basin (not shown) for subsequent disposal. When the plunger 3 reaches the forward end position, the closing device 13 is closed again to start a new flushing operation or normal injection operation.

As an alternative to a freely movable plunger arrangement, it is also possible to arrest the plunger 3 in any desired position within the cylinder 1, to close the closing mechanism 9, to open the closing device 13 in the flow channel 11 and to introduce melt through the inlet port 15 into the antechamber 7. As the plunger 3 is held in place in this configuration, melt can be withdrawn continuously through the flow channel 11. In order to flush the cylinder walls as thorough as possible, it may be appropriate to carry out several flushing operations, whereby the plunger 3 is locked in place at respectively different positions along its stroke.

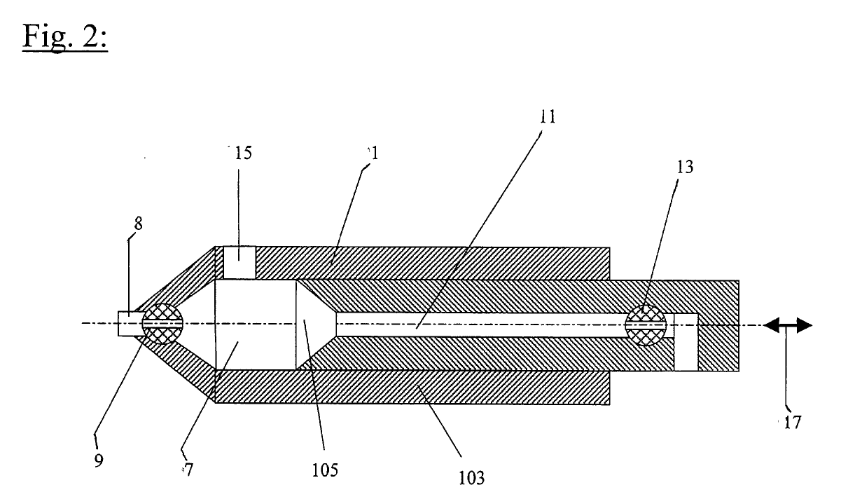

Referring now to FIG. 2, there is shown a sectional view of a second embodiment of a plunger-type injection molding unit according to the present invention. In the following description, parts corresponding with those in FIG. 1 are denoted by identical reference numerals and not explained again. This embodiment differs from the embodiment of FIG. 1 by the configuration of the plunger. Accordingly, the plunger 103 has a plunger end face 105 which tapers in the direction to the flow channel 11 in a funnel-shaped manner. In this way, the end face 105 can be better flushed and purged more quickly by the flow of melt.

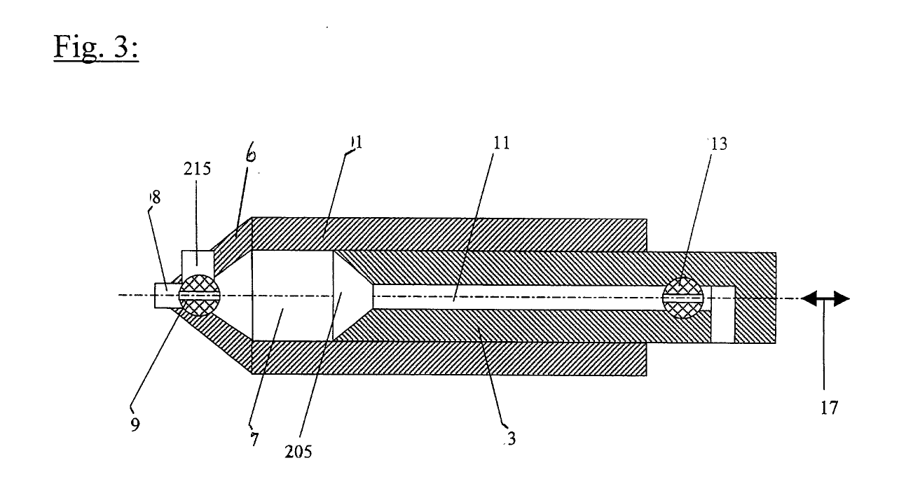

FIG. 3 shows a sectional view of a third embodiment of a plunger-type injection molding unit according to the present invention. In the following description, parts corresponding with those in FIG. 2 are denoted by identical reference numerals, and not explained again. This embodiment differs from the embodiment of FIG. 2 by the configuration of the inlet port. Accordingly, the inlet port 215 is arranged at the tip portion 5 of the cylinder 1 and is also controlled by the closing mechanism 9. Thus, the injection port 8 and the inlet port 215 are fluidly connected alternatingly by the closing mechanism 9 with the antechamber 7. This has the advantage that the forward portion of the antechamber 7 is completely and thoroughly flushed during the flushing operation as a consequence of the arrangement of the inlet port 215 at the forward end of the tip portion 6.

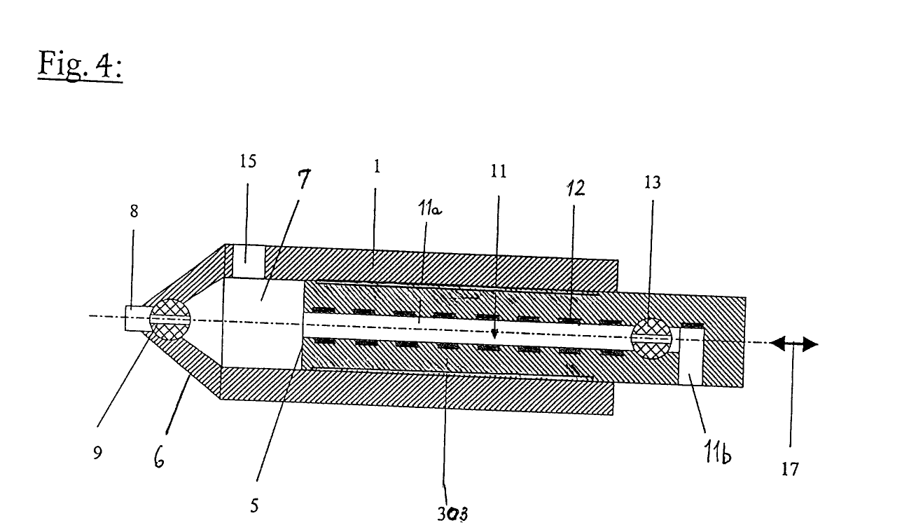

FIG. 4 shows a sectional view of another embodiment of a plunger-type injection molding unit according to the present invention. In the following description, parts corresponding with those in FIG. 1 are denoted by identical reference numerals, and not explained again. This embodiment differs from the embodiment of FIG. 1 by the configuration of the plunger which is designed as stepped plunger 303 to minimize friction between the plunger 303 and the cylinder 1. Further shown in FIG. 4 by way of example is the provision of heating elements 12 provided in the plunger 303 and extending substantially over the length of the flow channel 11 for maintaining melt in liquid state. Of course, the provision of the heating elements 12 are equally applicable in the embodiments of FIGS. 1, 2 and 3.

The injection molding units of FIGS. 2, 3 and 4 for carrying out a flushing process operate in a same manner as the injection molding unit of FIG. 1.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. An injection molding unit, comprising:
a cylinder;
a plunger received in the cylinder for axial displacement and having an end face defining with the cylinder ahead of the plunger an antechamber which receives melt through an inlet port, wherein the cylinder has an injection port in substantial confronting relationship to the end face of the plunger, said plunger having a flow channel to form a flushing opening for conducting melt from the antechamber;
a closing mechanism for regulating a flow of melt through the injection port; and
a closing device for regulating a flow of melt through the flow channel.

2. The injection molding unit of claim 1, and further comprising heating elements provided in the plunger and extending substantially over the length of the flow channel for maintaining the melt in liquid state.

3. The injection molding unit of claim 1, wherein the end face of the plunger has a shape enhancing flow dynamics to realize an effective flushing action.

4. The injection molding unit of claim 1, wherein the flow channel is configured in the form of an axial inner bore at least in an area of the end face of the plunger.

5. The injection molding unit of claim 1, wherein the end face of the plunger is tapered toward the inner bore in a funnel-shape manner.

6. The injection molding unit of claim 1, wherein the closing device is a valve.

7. The injection molding unit of claim 1, wherein the closing mechanism is a shut-off nozzle.

8. The injection molding unit of claim 1, wherein the closing mechanism is a control valve disposed in the melt inlet port so as to allow ejection of melt from the antechamber in a first end position and filling of the antechamber with melt in a second end position.

9. The injection molding unit of claim 1, wherein the plunger has a stepped configuration.

10. The injection molding unit of claim 1, and further comprising a discharge device for removing melt migrated to an area between the cylinder and the plunger.

11. The injection molding unit of claim 1, wherein the inlet port is formed in a forward portion of the cylinder in proximity of the injection port, said closing mechanism being configured to connect the injection port and the inlet port in alternating fashion with the antechamber.

12. A method of operating a plunger-type injection molding unit, comprising the steps of:
closing an injection port provided for ejection of melt from an antechamber of a plunger of an injection molding unit into an injection mold;
filling melt into the antechamber to thereby move the plunger backwards;
opening a closing device disposed within a flow channel of the plunger; and
moving the plunger forwards in axial direction to allow melt to flow to the outside through the flow channel.

13. The method of claim 12, and further comprising the step of closing the closing device before the filling step.

14. A method of operating a plunger-type injection molding unit, comprising the steps of:
closing an injection port provided for ejection of melt from an antechamber of a plunger of an injection molding unit into an injection mold;
opening a closing device disposed within a flow channel of the plunger; and
filling melt into the antechamber while keeping the plunger immobile and allowing melt to flow to the outside through the flow channel.

15. The method of claim 13, and further comprising the step of closing the closing device before the filling step.
